(19) United States
(12) Patent Application Publication
(10) Pub. No.: US 2013/0118278 A1
(43) Pub. Date: May 16, 2013

(54) DUST TEST SYSTEM

(71) Applicants: Qiang ZHANG, Wuhan City (CN); Yu-Lin LIU, Wuhan City (CN)

(72) Inventors: Qiang ZHANG, Wuhan City (CN); Yu-Lin LIU, Wuhan City (CN)

(73) Assignees: HON HAI PRECISION INDUSTRY CO., LTD., Tu-Cheng (TW); HONG FU JIN PRECISION INDUSTRY (WuHan) CO., LTD., Wuhan City (CN)

(21) Appl. No.: 13/550,681

(22) Filed: Jul. 17, 2012

(30) Foreign Application Priority Data
Nov. 15, 2011 (CN) 201110361343.7

(51) Int. Cl. G01N 17/00

(52) U.S. Cl. 73/865.6

(57) ABSTRACT

A dust test system includes a test chamber, a vibration apparatus mounted on the test chamber and a vibration control circuit electrically connected to the vibration apparatus. The test chamber is adapted to accommodate an electronic device. The vibration apparatus includes a vibration sieve mounted on the test chamber and at least one vibration motor linkage to the vibration sieve. A plurality of dust is laid on the vibration sieve. The vibration control circuit is adapted to receive a first AC voltage, and output a second AC voltage according to the first AC voltage. The at least one vibration motor is adapted to receive the second AC voltage and vibrate. The vibration sieve is adapted to vibrate together with the at least one vibration motor. The plurality of dust lying on the vibration sieve are dropped into the test chamber.

### BACKGROUND

1. Technical Field

The present disclosure relates to a dust test system for testing reliability of an electronic device under dust environment.

2. Description of Related Art

A dust test is an important test for determining the reliability of an electronic device. The functions of the electronic device are tested by simulating a dust environment, in the dust test chamber. However, a typical dust test chamber cannot control a flow rate of the dust in the dust test chamber, which may have an influence on precision of the test.

Therefore there is a need for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a dust test system, which comprises a vibration control circuit.

FIG. 2 is an isometric view of the dust test system of FIG. 1.

FIG. 3 is a circuit diagram of the vibration control circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

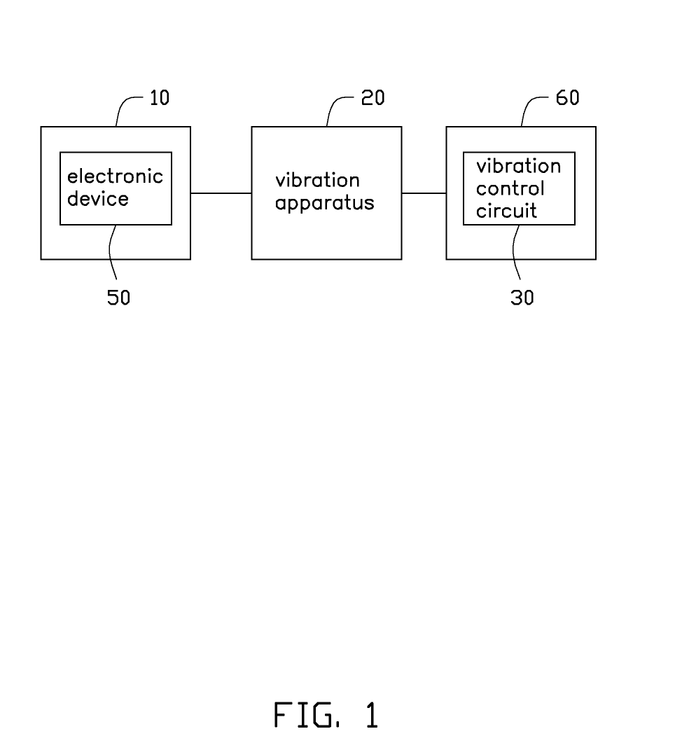

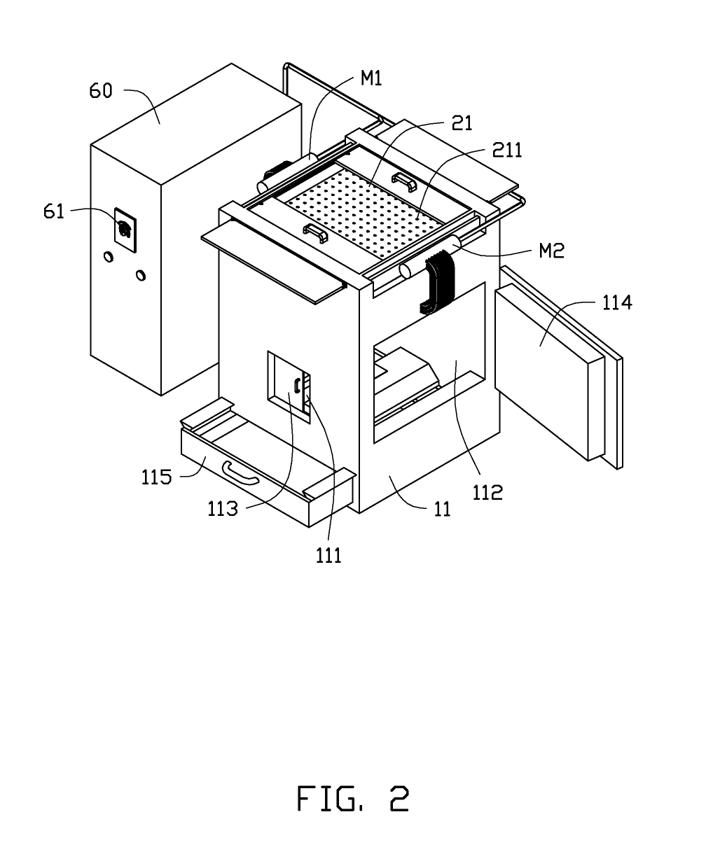

FIGS. 1 and 2, illustrate a dust test system in accordance with an embodiment. The dust test system includes a test chamber 10 adapted to accommodate an electronic device 50, a vibration apparatus 20 mounted on the test chamber 10 and a vibration control circuit 30 electrically connected to the vibration apparatus 20. In one embodiment, the vibration control circuit 30 is attached in a control chamber 60. A rate adjusting knob 61 is located on the control chamber 60.

The test chamber 10 includes a body 11. A first opening 111 and a second opening 112 are defined on two perpendicular sidewalls of the body 11. A first gate 113 is slidably mounted in the first opening 111. A second gate 114 is rotatably mounted in the second opening 112. A dust collecting box 115 is slidably mounted on a bottom of the body 11. In one embodiment, a dimension of the first opening 111 is less than a dimension of the second opening 112. A small sized electronic device 50 is put in the test chamber 10 via the first opening 111. A large sized electronic device 50 is put in the test chamber 10 via the second opening 112.

The vibration apparatus 20 includes a vibration sieve 21 mounted on a top of the body 11 and two vibration motors M1, M2 mounted on two sides of the body 11. The vibration motors M1, M2 link to the vibration sieve 21. A plurality of through holes 211 are defined on the vibration sieve 21. A plurality of dust is laid between the plurality of through holes 211 on the vibration sieve 21. The vibration motors M1, M2 are electrically connected to the vibration control circuit 30.

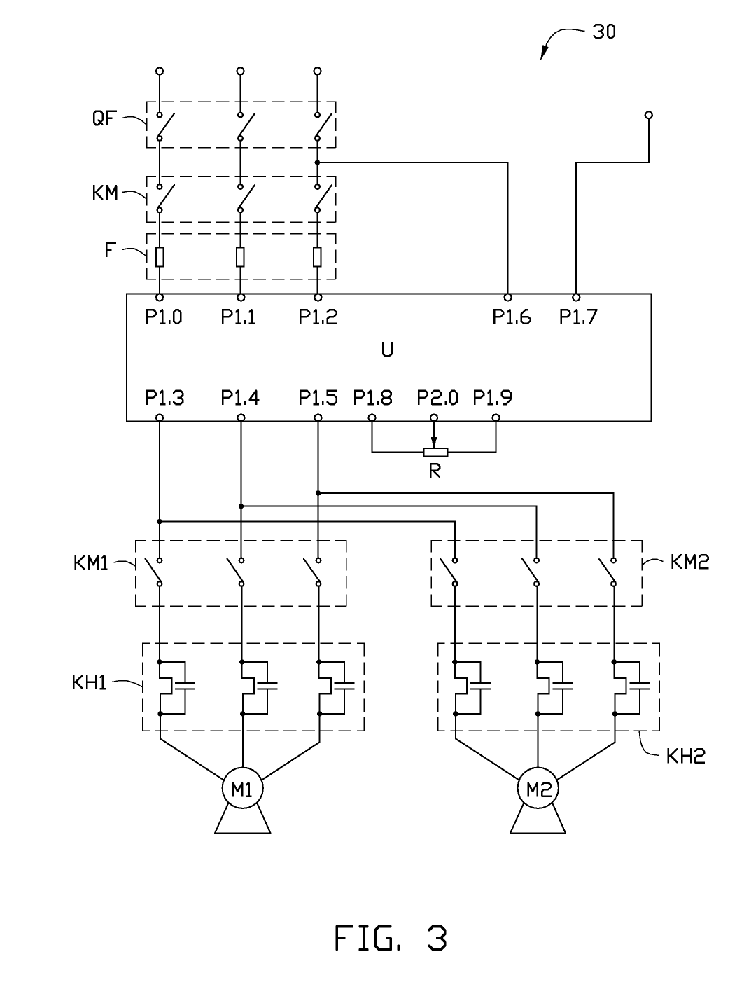

FIG. 3, illustrates the vibration control circuit 30 in accordance with one embodiment. The vibration control circuit 30 includes a frequency-variable controller U and a variable resistor R. The frequency-variable controller U includes three frequency-variable signal input terminals P1.0˜P1.2, three frequency-variable signal output terminals P1.3˜P1.5, a first voltage input terminal P1.6, a second voltage input terminal P1.7, a positive rate adjusting signal input terminal P1.8, a negative rate adjusting signal input terminal P1.9 and a first adjusting terminal 2.0. The frequency-variable signal input terminals P1.0˜P1.2 receive a first AC voltage via a fuse F, an input relay KM and a breaker QF electrically connected in series. The frequency-variable signal output terminals P1.3-˜P1.5 are grounded via a first output relay KM1, a first thermal relay KH1 and the vibration motor M1 electrically connected in series. The frequency-variable signal output terminals P1.3˜P1.5 are grounded via a second output relay KM2, a second thermal relay KH2 and the vibration motor M2 electrically connected in series.

The frequency-variable controller U outputs a second AC voltage at the frequency-variable signal output terminals P1.3˜P1.5 according to the first AC voltage. The first voltage input terminal P1.6 receives the first AC voltage via the breaker QF. The second first voltage input terminal P1.7 receives a third AC voltage. The positive rate adjusting signal input terminal P1.8 and the negative rate adjusting signal input terminal P1.9 are electrically connected to a first terminal and a second terminal of the variable resistor R respectively. The first adjusting terminal 2.0 is electrically connected to a second adjusting terminal of the variable resistor R. In one embodiment, the first AC voltage is a 380V three phase AC voltage. The rate adjusting knob 61 on the control chamber 60 is rotated to adjust a resistance of the variable resistor R by the second adjusting terminal of the variable resistor R.

In a working state, the electronic device 50 is put in the test chamber 10 via the first opening 111 or the second opening 112. The first gate 113 and the second gate 114 are closed. The dust test system receives the first AC voltage and is powered on. The rate adjusting knob 61 on the control chamber 60 is rotated to adjust a frequency of the second AC voltage at the frequency-variable signal output terminals P1.3˜P1.5 of the frequency-variable controller U. The vibration motors M1, M2 receives the second AC voltage of a special frequency and starts to vibrate. The vibration sieve 21 vibrates together with the vibration motors M1, M2. The plurality of dust lying on the vibration sieve 21 are dropped in the test chamber 10 through the plurality of through holes 211. The functions of the electronic device 50 are tested under a preset dust environment.

In one embodiment, the fuse F and the breaker QF are used to protect the input circuit of the dust test system. When a short circuit on the input circuit occurs, the fuse F blows to open the input circuit. The breaker QF is shut down manually to cut the first AC voltage off. The input relay KM, the first output relay KM1 and the second output relay KM2 are used to protect the frequency-variable controller U. When a short circuit on the input terminals of the frequency-variable controller U occurs, the input relay KM turns off to protect the frequency-variable controller U. When a short circuit on the output terminals of the frequency-variable controller U occurs, the first output relay KM1 and the second output relay KM2 turn off to protect the frequency-variable controller U. The first thermal relay KH1 and the second thermal relay KH2 are used to protect the vibration motors M1, M2. When the vibration motors M1, M2 are overloaded, the first thermal relay KH1 and the second thermal relay KH2 turn off to protect the vibration motors M1, M2 respectively.

Even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A dust test system comprising:
a test chamber adapted to accommodate an electronic device;
a vibration apparatus mounted on the test chamber; the vibration apparatus comprises a vibration sieve mounted on the test chamber and at least one vibration motor linkage to the vibration sieve; a plurality of dusts are laid on the vibration sieve; and
a vibration control circuit electrically connected to the vibration apparatus; the vibration control circuit comprises a frequency-variable controller comprising a plurality of frequency-variable signal input terminals and a plurality of frequency-variable signal output terminals; the plurality of frequency-variable signal input terminals are adapted to receive a first AC voltage; the plurality of frequency-variable signal output terminals are grounded via the at least one vibration motor; the frequency-variable controller is adapted to output a second AC voltage at the plurality of frequency-variable signal output terminals according to the first AC voltage; the at least one vibration motor is adapted to receive the second AC voltage and vibrate; the vibration sieve is adapted to vibrate together with the at least one vibration motor; and the plurality of dusts laid on the vibration sieve are dropped in the test chamber.

2. The dust test system of claim 1, wherein the vibration control circuit further comprises a variable resistor; the frequency-variable controller further comprises a positive rate adjusting signal input terminal, a negative rate adjusting signal input terminal and a first adjusting terminal; the positive rate adjusting signal input terminal and the negative rate adjusting signal input terminal are electrically connected to a first terminal and a second terminal of the variable resistor respectively; and the first adjusting terminal is electrically connected to a second adjusting terminal of the variable resistor.

3. The dust test system of claim 2, wherein the vibration control circuit further comprises a fuse, an input relay and a breaker; and the frequency-variable signal input terminals are adapted to receive the first AC voltage via a fuse, the input relay KM and the breaker electrically connected in series.

4. The dust test system of claim 2, wherein the vibration control circuit further comprises a first output relay, a first thermal relay, a second output relay and a second thermal relay; the frequency-variable signal output terminals of the frequency-variable controller are grounded via the first output relay, the first thermal relay and the at least one vibration motor electrically connected in series; and the frequency-variable signal output terminals of the frequency-variable controller are grounded via the second output relay, the second thermal relay and the at least one vibration motor electrically connected in series.

5. The dust test system of claim 3, wherein the vibration control circuit further comprises a first voltage input terminal and a second voltage input terminal; the first voltage input terminal is adapted to receive the first AC voltage via the breaker; and the second first voltage input terminal is adapted to receive a third AC voltage.

6. The dust test system of claim 5, wherein the test chamber comprises a body; a first opening and a second opening are defined on the body; a first gate is slidably mounted in the first opening; a second gate is rotatably mounted in the second opening; and a dust collecting box is slidably mounted on a bottom of the body.

7. The dust test system of claim 6, wherein a plurality of through holes are defined on the vibration sieve; and a plurality of dusts are laid between the plurality of through holes on the vibration sieve.

8. The dust test system of claim 6, wherein a dimension of the first opening is less than a dimension of the second opening; a small sized electronic device is put in the test chamber via the first opening; and a large sized electronic device is put in the test chamber via the second opening.

9. The dust test system of claim 5, wherein the vibration control circuit is attached in a control chamber; a rate adjusting knob is located on the control chamber; and the rate adjusting knob on the control chamber is rotated to adjust a frequency of the second AC voltage at the frequency-variable signal output terminals of the frequency-variable controller.

10. A dust test system comprising:
a test chamber adapted to accommodate an electronic device;
a vibration apparatus mounted on the test chamber; the vibration apparatus comprises a vibration sieve mounted on the test chamber and at least one vibration motor linkage to the vibration sieve; a plurality of dusts are laid on the vibration sieve; and
a vibration control circuit electrically connected to the vibration apparatus; the vibration control circuit is adapted to receive a first AC voltage, and output a second AC voltage according to the first AC voltage; the at least one vibration motor is adapted to receive the second AC voltage and vibrate; the vibration sieve is adapted to vibrate together with the at least one vibration motor; and the plurality of dusts laid on the vibration sieve are dropped in the test chamber.

11. The dust test system of claim 10, wherein the vibration control circuit comprises a frequency-variable controller having a plurality of frequency-variable signal input terminals and a plurality of frequency-variable signal output terminals; the plurality of frequency-variable signal input terminals are adapted to receive the first AC voltage; the plurality of frequency-variable signal output terminals are grounded via the at least one vibration motor; the frequency-variable controller is adapted to output the second AC voltage at the plurality of frequency-variable signal output terminals according to the first AC voltage.

12. The dust test system of claim 11, wherein the vibration control circuit further comprises a variable resistor; the frequency-variable controller further comprises a positive rate adjusting signal input terminal, a negative rate adjusting signal input terminal and a first adjusting terminal; the positive rate adjusting signal input terminal and the negative rate adjusting signal input terminal are electrically connected to a first terminal and a second terminal of the variable resistor respectively; and the first adjusting terminal is electrically connected to a second adjusting terminal of the variable resistor.

13. The dust test system of claim 12, wherein the vibration control circuit further comprises a fuse, an input relay and a breaker; and the frequency-variable signal input terminals are adapted to receive the first AC voltage via a fuse, the input relay KM and the breaker electrically connected in series.

14. The dust test system of claim 12, wherein the vibration control circuit further comprises a first output relay, a first thermal relay, a second output relay and a second thermal relay; the frequency-variable signal output terminals of the frequency-variable controller are grounded via the first output relay, the first thermal relay and the at least one vibration motor electrically connected in series; and the frequency-variable signal output terminals of the frequency-variable controller are grounded via the second output relay, the second thermal relay and the at least one vibration motor electrically connected in series.

15. The dust test system of claim 13, wherein the vibration control circuit further comprises a first voltage input terminal and a second voltage input terminal; the first voltage input terminal is adapted to receive the first AC voltage via the breaker; and the second first voltage input terminal is adapted to receive a third AC voltage.

16. The dust test system of claim 15, wherein the test chamber comprises a body; a first opening and a second opening are defined on the body; a first gate is slidably mounted in the first opening; a second gate is rotatably mounted in the second opening; and a dust collecting box is slidably mounted on a bottom of the body.

17. The dust test system of claim 16, wherein a plurality of through holes are defined on the vibration sieve; and a plurality of dusts are laid between the plurality of through holes on the vibration sieve.

18. The dust test system of claim 16, wherein a dimension of the first opening is less than a dimension of the second opening; a small sized electronic device is put in the test chamber via the first opening; and a large sized electronic device is put in the test chamber via the second opening.

19. The dust test system of claim 15, wherein the vibration control circuit is attached in a control chamber; a rate adjusting knob is located on the control chamber; and the rate adjusting knob on the control chamber is rotated to adjust a frequency of the second AC voltage at the frequency-variable signal output terminals of the frequency-variable controller.
